(19) United States
(12) Patent Application Publication
(10) Pub. No.: US 2006/0080621 A1
(43) Pub. Date: Apr. 13, 2006

(54) Method of controlling location of display window on display screen of information processing device and apparatus using the method

(75) Inventor: Jeong-hun Park, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/214,942

(22) Filed: Aug. 31, 2005

(30) Foreign Application Priority Data
Oct. 13, 2004 (KR) 10-2004-0081776

(51) Int. Cl. G06F 3/00

(52) U.S. Cl. 715/788; 715/798

(57) ABSTRACT

Provided is a method of controlling a location of a display window on a display screen of an information processing device, and an apparatus using the method. The method of controlling location of a display window includes: displaying the display window on the display screen; and moving the display window on the display screen based on a moving speed and a moving direction of a touch input on the display window. Thus, a terminal incapable of a precise touch input due to a physically small-sized screen of a high resolution makes it possible to move an interactive window or provide a hiding function owing to a user-friendly operation, thereby providing a user with convenience.

### CROSS-REFERENCE TO RELATED APPLICATION

This application claims the benefit of Korean Patent Application No. 10-2004-0081776, filed on Oct. 13, 2004, in the Korean Intellectual Property Office, the disclosure of which is incorporated herein in its entirety by reference.

### BACKGROUND OF THE INVENTION

1. Field of the Invention

The present invention relates to an information processing device, and more particularly, to a method of controlling a location of a display window on a display screen of an information processing device, and an apparatus using the method.

2. Description of the Related Art

A portable compact terminal with no keyboard employs a data input method using keyboard software in which a keyboard image is displayed on a display screen for a user's input, and a character is selected using a pointing device such as a mouse. A keyboard image is illustrated in FIG. 1.

FIG. 1 is a reference diagram illustrating move and hiding functions of a conventional software keyboard. Referring to FIG. 1, a software keyboard window 110 displays a data input region 120 to display a key corresponding to a character or a number in the window, and a location move region 130 to move a software keyboard to a different location of a display screen. When a software keyboard window hides an application window displayed on the display screen, a user points to a location move region using a pointing device, such as a mouse, and drags and drops the software keyboard window to a different location on the display screen.

A touchdown/touchup event, a move event, and coordinates are input in a display unit 100 including a touch panel and a display panel. This is the same as the touch driver input.

A function to be realized based on the input data is a Drag & Drop. When a touchdown is sensed in a region capable of dragging, i.e., a stylus points to a display screen for dragging, a rectangle is drawn outside to display a location. When a touchup is sensed in a desired location, i.e., a stylus drops from a display screen, a software keyboard window is moved to a desired location. Thus, the user can move a software keyboard window to a desired location.

Touching an end button 140 in a predetermined region of the software keyboard window makes it possible to hide the software keyboard window. Touching the end button results in not an end of a software keyboard but a hiding thereof. That is, the software keyboard is hidden on the display screen while it is being executed.

The drag & drop function or the end function using a mouse in a desktop window is a convenient technology. However, it is difficult for a user to finely use these functions in an information terminal using a touch input, which is more difficult to use than a mouse.

A software keyboard that is an executing dial has a different characteristic. A software keyboard is frequently used in the same manner that a hardware keyboard is used, and is hidden rather than ended. A frequent use of a soft keyboard requires its continuous residence in order to reduce a loading time. Under such circumstances, a drag & drop function and an end function have to be improved. Since a mobile terminal has a small-sized display screen, a software keyboard has to be frequently moved to the top of the display screen. Thus, since the software keyboard also has a small-sized window, it is not easy to push an end button of a title bar in the software keyboard with a finger to access a function that hides the keyboard.

Although the use of the software keyboard using a touch input is limited only to some devices at present, the above requirements should be satisfied in view of the rapid increase of mobile Internet devices.

### SUMMARY OF THE INVENTION

Additional aspects and/or advantages of the invention will be set forth in part in the description which follows and, in part, will be apparent from the description, or may be learned by practice of the invention.

The present invention provides a method of controlling a location of a display window on a display screen of an information processing device, and an apparatus using the method.

According to an aspect of the present invention, there is provided a method of controlling a location of a display window on a display screen of an information processing device, the method including: displaying the display window on the display screen; and moving the display window on the display screen based on a moving speed and a moving direction of a touch input on the display window.

The moving of the display window may include moving the display window to an edge of the display screen when the moving speed of the touch input is larger than a predetermined threshold.

The moving of the display window may further include moving the display window to the right of the display screen when the moving direction of the touch input is between −22.5° and 22.5°; moving the display window to the top right of the display screen when the moving direction of the touch input is between 22.5° and 67.5°; moving the display window to the top of the display screen when the moving direction of the touch input is between 67.5° and 112.5°; moving the display window to the top left of the display screen when the moving direction of the touch input is between 112.5° and 157.5°; moving the display window to the left of the display screen when the moving direction of the touch input is between 157.5° and −157.5°; moving the display window to the bottom left of the display screen when the moving direction of the touching is between −157.5° and −112.5°; moving the display window to the bottom of the display screen when the moving direction of the touch input is between −112.5° and −67.5°; and moving the display window to a bottom right of the display screen when a moving direction of the touch input is between −67.5° and −22.5°.

According to another aspect of the present invention, there is provided a method of controlling a location of a display window on a display screen of an information processing device, the method including: displaying the display window on the display screen; and hiding the display window on the display screen by double-clicking a location move region of the display window.

According to still another aspect of the present invention, there is provided an apparatus for controlling a location of a display window on a display screen of an information processing device, the apparatus including: a display unit displaying the display window on the display screen; and a processing unit instructing the display unit to move the display window on the display screen based on a moving speed and a moving direction of a touch input on the display window.

According to yet another aspect of the present invention, there is provided an apparatus for controlling a location of a display window on a display screen of an information processing device, the apparatus including: a display unit displaying the display window on the display screen; and a processing unit instructing the display unit to hide the display window on the display screen by double-clicking a location move region of the display window.

### BRIEF DESCRIPTION OF THE DRAWINGS

The above and other features and advantages of the present invention will become more apparent by describing in detail exemplary embodiments thereof with reference to the attached drawings in which:

FIG. 1 is a reference diagram illustrating move and hiding functions of a conventional software keyboard;

FIG. 2 is a block diagram schematically illustrating a computer device for processing move and hiding functions of a software keyboard according to an embodiment of the present invention;

FIG. 3 is a reference diagram illustrating move and hiding functions of a software keyboard according to an embodiment of the present invention;

FIG. 4 is a reference diagram illustrating a moving direction of a software keyboard according to an embodiment of the present invention; and

FIGS. 5A to 5C are flowcharts describing a method of controlling a moving location move of a software keyboard according to an embodiment of the present invention.

FIG. 5D is a reference diagram illustrating a movement of touchdown point according to an embodiment of the present invention

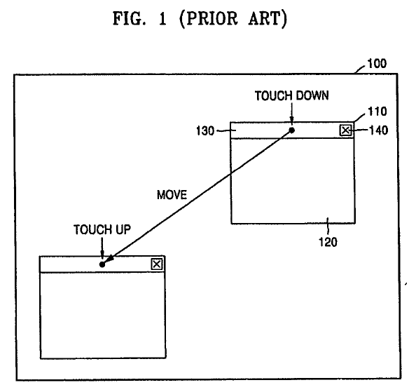

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, the present invention will now be described more fully with reference to the accompanying drawings, in which embodiments of the invention are shown.

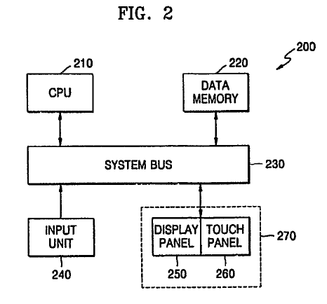

FIG. 2 is a block diagram schematically illustrating a computer device for processing move and hiding functions of a software keyboard according to an embodiment of the present invention. Referring to FIG. 2, a computer device 200 includes a Central Processing Unit (CPU) 210, a data memory 220, a system bus 230, an input unit 240, and a display unit 270 including a display panel 250, and a touch panel 260.

The CPU 210 loads a program stored in a nonvolatile memory device to a program region of ROM to control elements in the computer device. A nonvolatile memory device or RAM can be used as a data memory 220 shown in FIG. 2. The CPU 210 executes a software program such as a user interface program or an application program in an operation system that functions as multitask and multiwindow. A software keyboard program is one of the user interface programs.

The display unit 270 includes the display panel 250 and the touch panel 260, and controls video data displayed in the display unit according to the operation of the CPU 210. When a pointing input device such as a finger or a stylus touches the surface of the panel, the touch panel 260 detects a touch coordinate location, and transfers it to the CPU 210. The input unit 240 may be an information input device such as a keyboard. The system bus 230 is for data communication between the CPU 210 and the elements in the computer device, and between the elements.

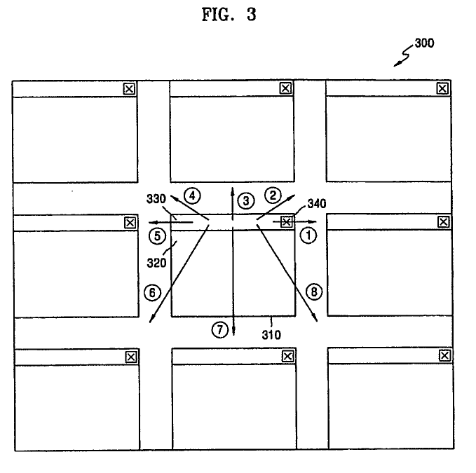

FIG. 3 is a reference diagram illustrating move and hiding functions of a software keyboard according to an embodiment of the present invention. Referring to FIG. 3, an operation of a computer device configured as above will now be described.

A CPU 210 executes a user application program such as a text editor, and displays a software keyboard program in a display panel 250. To be more specific, the CPU 210 displays input data in a target window based on an output signal from a touch panel, or changes a location to place input data in a display panel of the software keyboard.

The CPU 210 displays a software keyboard window 310 in a display panel 300 according to an input content of an input device. The software keyboard window 310 includes a character input region 320 for inputting a character regarding a user application, and a window move region 330, i.e., a title bar, for moving to a different location.

The character input region 320 includes a character input button to input a character. The window move region 330 includes an end button 340 for ending the software keyboard. The window move region 330 except the end button 340 is dragged by touchdown to move the software keyboard window 310 to a location where it is released by touchup.

When a user points to a location corresponding to a character input button of a touch panel using a finger or a stylus, the CPU 210 displays data converted from character data input using a character input button as input data in a display panel 250.

In particular, according to an embodiment of the present invention, when a user touches the window move region 330 and moves the finger toward a predetermined direction using a finger or a stylus, the CPU 210 moves the software keyboard window 310 to the edge of a display screen in the predetermined direction when a touch speed is faster than a predetermined speed. When a user wants to change the location of the software keyboard window 310 on the display screen, a user simply touches the window move region 330 at a speed faster than a predetermined speed without finely operating a software keyboard window in order to move a software keyboard window to the edge of a display screen. This provides a user with an increased convenience.

As shown in FIG. 3, when a touch direction is \textcircled{1}, and a touch speed is faster than a predetermined speed, the CPU controls a display unit to move the software keyboard to the right of the display screen.

When a touch direction is \textcircled{2}, and a touch speed is faster than a predetermined speed, the CPU controls a display unit to move the software keyboard 310 to the top right of the display screen.

When a touch direction is \textcircled{3}, and a touch speed is faster than a predetermined speed, the CPU controls a display unit to move the software keyboard to the top of the display screen.

When a touch direction is \textcircled{4}, and a touch speed is faster than a predetermined speed, the CPU controls a display unit to move the software keyboard to the top left of the display screen.

when a touch direction is \textcircled{5}, and a touch speed is faster than a predetermined speed, the CPU controls a display unit to move the software keyboard to the left of the display screen.

When a touch direction is \textcircled{6}, and a touch speed is faster than a predetermined speed, the CPU controls a display unit to move the software keyboard to the bottom left of the display screen.

When a touch direction is \textcircled{7}, and a touch speed is faster than a predetermined speed, the CPU controls a display unit to move the software keyboard to the bottom of the display screen.

When a touch direction is \textcircled{8}, and a touch speed is faster than a predetermined speed, the CPU controls a display unit to move the software keyboard to the bottom right of the display screen.

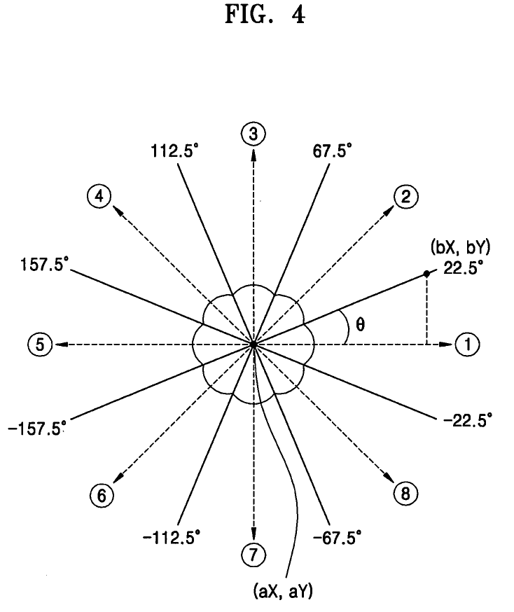

FIG. 4 is a reference diagram illustrating a moving direction of the software keyboard according to an embodiment of the present invention. Hereinafter, an example of a basis for determining a move direction for touch will now be described with reference to FIG. 4.

Referring to FIG. 4, when a moving direction is between −22.5° and 22.5°, and is determined as \textcircled{1}, a display window is moved to the right of a display screen.

When a moving direction is between 22.5° and 67.5°, and is determined as \textcircled{2}, a display window is moved to the top right of a display screen.

When a moving direction is between 67.5° and 112.5°, and is determined as \textcircled{3}, a display window is moved to the top of a display screen.

When a moving direction is between 112.5° and 157.5°, and is determined as \textcircled{4}, a display window is moved to the top left of a display screen.

When a moving direction is between 157.5° and −157.5°, and is determined as \textcircled{5}, a display window is moved to the left of a display screen.

When a moving direction is between −157.5° and −112.5°, and is determined as \textcircled{6}, a display window is moved to the bottom left of a display screen.

When a moving direction is between −112.5° and −67.5°, and is determined as \textcircled{7}, a display window is moved to the bottom of a display screen.

When a moving direction is between −67.5° and −22.5°, and is determined as \textcircled{8}, a display window is moved to the bottom right of a display screen.

FIG. 4 shows that a software keyboard window is moved to eight locations of the display screen according to a touch direction. However, it is possible to variously change a location to move the software keyboard window, increase the number of moving directions to obtain a more precise control, and decrease the number of moving directions to obtain a simple realization of a system using the software keyboard.

Touching the window move region of the software keyboard window at a speed faster than a predetermined speed makes it possible for the software keyboard window to move to every edge of the display screen without exactly dragging the software keyboard window.

Since a mobile terminal has a small-sized display panel, the software keyboard window and an end button prepared in a location move region of the software keyboard window are naturally small. Therefore, it is difficult to precisely control the end button. According to an embodiment of the present invention, a user double-clicks a location move region using a finger or a stylus, which is sensed, and is controlled to hide a software keyboard window in a display panel by a CPU. This is not an end of a software keyboard application but a hiding thereof in a display unit.

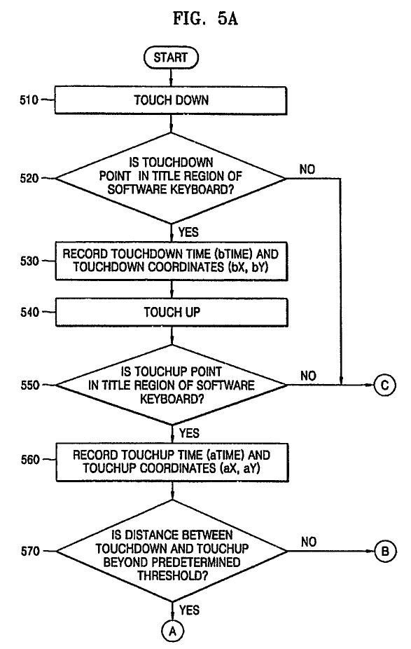

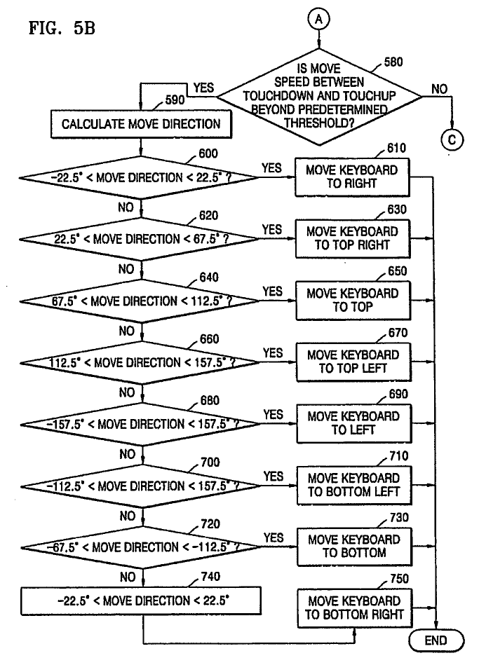

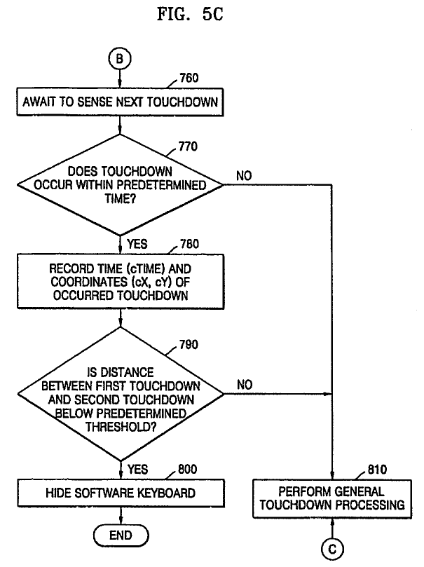

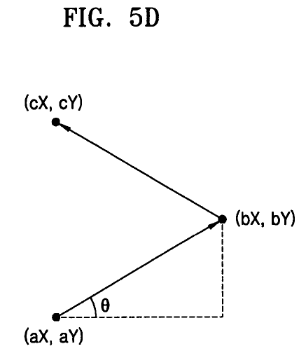

FIGS. 5A to 5C are flowcharts of a method of controlling a moving location of the software keyboard and FIG. 5D shows that a movement of touchdown point according to an embodiment of the present invention.

The touch panel 260 senses a touchdown of an input device such as a stylus in Operation 510. The CPU 210 determines whether a touchdown point is in a title region (window move region) of the software keyboard window in Operation 520.

Referring to FIG. 5D, when the touchdown point is not in the title region 330 of a software keyboard, the CPU 210 proceeds to \textcircled{C} and performs a general touchdown processing in Operation 810. When the touchdown point is in the title region 330 of the software keyboard window, the CPU 210 records a touchdown time (bTime) and touchdown coordinates (bX, bY) in Operation 530.

The touch panel 260 senses a touchup of an input device in Operation 540. The CPU 210 determines whether a touchup point is in the title region 330 of the software keyboard window in Operation 550.

When the touchup point is not in the title region of the software keyboard window, the CPU 210 proceeds to \textcircled{c} and performs a general touchdown processing in Operation 810. When the touchup point is in the title region 330 of the software keyboard, the CPU 210 records a touchup time (aTime) and touchup coordinates (aX, aY) in Operation 560.

The CPU 210 determines whether the distance between the touchdown point and the touchup point is larger than a predetermined threshold in Operation 570 using the equation below.
SQRT((aX−bX)²+(aY−bY)²)>α1

This is in order to move the software keyboard window to a new location when the distance between the touchdown point and the touchup point is only larger than a predetermined distance threshold. When the distance between a touchdown and a touchup is beyond the predetermined distance threshold, the CPU 210 proceeds to \textcircled{a}. When the distance between the touchdown point and the touchup point is not larger than the predetermined distance threshold, the CPU 210 proceeds to \textcircled{b}. In case of \textcircled{a}, the CPU 210 determines whether the moving speed between a touchdown point and a touchup is larger than a predetermined speed threshold in Operation 580 using the equation below.
SQRT((aX−bX)²+(aY−bY)²)/(aTime−bTime)>α2

When the moving speed between the touchdown and the touchup is not larger than the predetermined speed threshold, the CPU 210 proceeds to \textcircled{c}, and performs a general touchdown processing in Operation 810.

When the move speed between a touchdown and a touchup is beyond the predetermined speed threshold, the CPU 210 calculates a moving direction in Operation 590 using the equation below.

$$θ = {tan}^{- 1} \frac{\vert bY - aY \vert}{\vert bX - aX \vert}$$

When the calculated moving direction (θ) is between −22.5° to 22.5° in Operation 600, the CPU 210 controls a display unit to move the display window to the right of the display screen in Operation 610.

When the moving direction (θ) is between 22.5° and 67.5° in Operation 620, the CPU 210 controls a display unit to move the display window to the top right of the display screen in Operation 630.

When the moving direction (θ) is between 67.5° and 112.5° in Operation 640, the CPU 210 controls a display unit to move the display window to the top of the display screen in Operation 650.

When the moving direction (θ) is between 112.5° and 157.5° in Operation 660, the CPU 210 controls a display unit to move the display window to the top left of the display screen in Operation 670.

When the moving direction (θ) is between 157.5° and −157.5° in Operation 680, the CPU 210 controls a display unit to move the display window to the left of the display screen in Operation 690.

When the moving direction (θ) is between −157.5° and −112.5° in Operation 700, the CPU 210 controls a display unit to move the display window to the bottom left of the display screen in Operation 710.

When the moving direction (θ) is between −112.5° and −67.5° in Operation 720, the CPU 210 controls a display unit to move the display window to the bottom of the display screen in Operation 730.

When the moving direction (θ) is between −67.5° and −22.5° in Operation 740, the CPU 210 controls a display unit to move the display window to the bottom right of the display screen in Operation 750.

In case of \textcircled{b}, the CPU 210 awaits to sense a next touchdown in Operation 760.

The CPU 210 determines whether a second touchdown occurs within a predetermined time (threshold), i.e., the touch panel senses a touchdown in Operation 770.

When the second touchdown does not occur within the predetermined time, the CPU 210 performs a general touchdown processing in Operation 810.

When the second touchdown occurs within a predetermined time, the CPU 210 records a time (cTime) and coordinates (cX, cY) of the touchdown in Operation 780.

The CPU 210 determines whether the distance between a first touchdown point and a second touchdown point is below a predetermined distance threshold in Operation 790 using the equation below.
SQRT((cX−bX)²+(cY−bY)²)>α3

When the CPU 210 determines that the distance between the first touchdown point and the second touchdown point is below the predetermined distance threshold, it controls a display unit to hide the software keyboard window in a display screen in Operation 800.

When the CPU 210 determines that the distance between the first touchdown point and the second touchdown point is not below the predetermined distance threshold, it performs a general touchdown processing in Operation 810.

As described above, although the software keyboard window is moved to the edge of the display screen based on the touch speed and direction, the method according to an embodiment of the present invention is not limited to a software keyboard but can be applied to any display windows displayed on a screen of a computer device.

Also, although a touching point belongs to a location move region of the software keyboard 330, i.e., a title bar, the method according to an embodiment of the present invention is not limited to the title bar but can be applied to any portions of a software keyboard.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. A functional program, code, and code segments used to implement the present invention can be derived by a skilled computer programmer from the description of the invention contained herein.

As described above, according to an embodiment of the present invention, a user-friendly operation makes it possible to move an interactive window or provide a hiding function in order for a terminal incapable of a precise touch due to a physically small-sized screen of a high resolution, thereby providing a user with convenience. A method of moving an interactive window according to an embodiment of the present invention has a wider range of effects in a portable Internet environment.

While the present invention has been particularly shown and described with reference to exemplary embodiments thereof, it will be understood by those of ordinary skill in the art that various changes in form and details may be made therein without departing from the spirit and scope of the present invention as defined by the following claims.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of controlling a location of a display window on a display screen of an information processing device, the method comprising:
displaying the display window on the display screen; and
moving the display window to a predetermined position of the display screen based on a moving speed of a touch input on the display window.

2. The method of controlling a location of a display window of claim 1, wherein the predetermined position of the display screen is an edge of the display screen when the moving speed of the touch input is larger than a predetermined threshold.

3. The method of claim 1, further comprising:
moving the display window on the predetermined position of the display screen based on a moving direction of the touch input on the display window.

4. The method of controlling a location of display window of claim 1, further comprising:
virtually dividing an edge of the display screen into a plurality of sector;
sensing the moving direction of the touch input; and
moving the display window to one of the plurality of sector based upon the sensed the moving direction of the touch input.

5. The method of claim 4, further wherein the moving the display window comprises:
comparing sensed the moving direction of the touch input and the plurality of sector;
determining a nearest sector of the plurality of sector by checking the sensed the direction of the touch input; and
moving the display window to the determined nearest sector of the plurality of sector.

6. The method of claim 4, wherein the plurality of sector are positioned at four corners of the display window.

7. The method of controlling a location of a display window of claim 3, wherein the moving of the display window further comprises:
moving the display window to the right of the display screen when the moving direction of the touch input is between −22.5° and 22.5°;
moving the display window to the top right of the display screen when the moving direction of the touch input is between 22.5° and 67.5°;
moving the display window to the top of the display screen when the moving direction of the touch input is between 67.5° and 112.5°;
moving the display window to the top left of the display screen when the moving direction of the touch input is between 112.5° and 157.5°;
moving the display window to the left of the display screen when the moving direction of the touch input is between 157.5° and −157.5°;
moving the display window to the bottom left of the display screen when the moving direction of the touching is between −157.5° and −112.5°;
moving the display window to the bottom of the display screen when the moving direction of the touch input is between −112.5° and −67.5°; and
moving the display window to a bottom right of the display screen when a moving direction of the touch input is between −67.5° and −22.5°.

8. A method of controlling a location of a display window on a display screen of an information processing device, the method comprising:
displaying the display window on the display screen; and
hiding the display window on the display screen responsive to a double-clicking of a location move region of the display window.

9. The method of claim 8, wherein the hiding the display window on the display screen further comprises:
recording a time and coordinates when a first touchdown is occurred;
checking whether a second touchdown occurs within a predetermined time from the first touchdown; and
hiding a software keyboard if the second touchdown is occurred within the predetermined time from the first touchdown.

10. An apparatus for controlling a location of a display window on a display screen of an information processing device, the apparatus comprising:
a display unit displaying the display window on the display screen; and
a processing unit instructing the display unit to move the display window on the display screen based on a moving speed and a moving direction of a touch input on the display window.

11. The apparatus for controlling a location of a display window of claim 10, wherein the processing unit instructs the display unit to move the display window to an edge of the display screen when a moving speed of the touch input is larger than a predetermined threshold.

12. The apparatus for controlling a location of a display window of claim 11, wherein the edge of the display screen is one of four corners of the display screen unit.

13. The apparatus for controlling a location of a display window of claim 11, wherein the processing unit further comprises:
moving the display window to the right of the display screen when the move direction of the touch input is between −22.5° and 22.5°;
moving the display window to the top right of the display screen when the move direction of the touch input is between 22.5° and 67.5°;
moving the display window to the top of the display screen when the move direction of the touch input is between 67.5° and 112.5°;
moving the display window to the top left of the display screen when the move direction of the touch input is between 112.5° and 157.5°;
moving the display window to the left of the display screen when the move direction of the touch input is between 157.5° and −157.5°;
moving the display window to the bottom left of the display screen when the move direction of the touch input is between −157.5° and −112.5°;
moving the display window to the bottom of the display screen when the move direction of the touch input is between −112.5° and −67.5°; and
moving the display window to the bottom right of the display screen when the move direction of the touch input is between −67.5° and −22.5°.

14. The apparatus for controlling a location of a display window on a display screen of an information processing device, the apparatus comprising:
a display unit displaying the display window on the display screen; and
a processing unit instructing the display unit to hide the display window on the display screen by double-clicking a location move region of the display window.

15. A method of controlling a location of a display window on a display screen of an information processing device, the method comprising:
displaying the display window on the display screen; and
virtually dividing the display screen into a plurality of sectors; and
moving the display window to a one of the plurality of sectors based on a moving speed and/or a moving direction of a touch input on the display window.

16. The method of claim 15, wherein the dividing the display screen is an edge region of the display screen.

17. A PDA (Personal Digital Assistant) having the method of claim 1.

18. A camera having the method of claim 1.
